(19) United States
(12) Patent Application Publication
(10) Pub. No.: US 2006/0070886 A1
(43) Pub. Date: Apr. 6, 2006

(54) Methods of removing sulfur from a fuel cell electrode

(75) Inventors: James H Saunders, Worthington, OH (US); Alan J Markworth, Columbus, OH (US); Caroline M Markworth, Columbus, OH (US); Bradley C Glenn, Hilliard, OH (US); Barry Hindin, Reynoldsburg, CH (US)

Correspondence Address: BATTELLE MEMORIAL INSTITUTE, 505 KING AVENUE, COLUMBUS, OH, 43201-2693, US

(73) Assignee: Battelle Memorial Institute, Columbus, OH (US)

(21) Appl. No.: 10/537,503

(22) PCT Filed: Dec. 5, 2003
(86) PCT No.: PCT/US03/39037

§ 371 Date: Jun. 3, 2005

Related U.S. Application Data
(60) Provisional application No. 60/431,051, filed on Dec. 5, 2002.
(60) Provisional application No. 60/445,681, filed on Feb. 6, 2003.

(51) Int. Cl. C25C 1/00; H01M 8/00

(52) U.S. Cl. 205/341; 205/343; 429/13

(57) ABSTRACT

A method of optimizing a waveform of an electrical current applied to an electrode includes the steps of: applying an electrical current to an electrode of a device; determining a waveform of the voltage or the current of the electrical current; representing the waveform by a mathematical description such as a number of points or an analytical function characterized by a number of unknown coefficients and a fixed number of known functions; measuring a function of the device associated with the application of the electrical current; feeding the waveform description and the measurements to an algorithm, which may be in a computer program or other calculating device including manual calculations, including an optimization routine which uses the points or coefficients as independent variables for optimizing the function of the device; and performing the calculations to determine values of the points or coefficients which optimize the function of the device, and thereby determine an optimized waveform of the electrical current to be applied to the electrode of the device. The application of the electrical current is effective to remove a sulfur contaminant from the electrode.

### CROSS-REFERENCE TO RELATED APPLICATIONS

This application incorporates by reference U.S. provisional application Ser. No. 60/354,713, filed Feb. 6, 2002. This application incorporates by reference and claims the benefit of U.S. provisional application Ser. No. 60/431,051, filed Dec. 5, 2002. This application incorporates by reference and claims the benefit of U.S. provisional application Ser. No. 60/445,681, filed Feb. 6, 2003.

### TECHNICAL FIELD

This invention relates to methods of removing a sulfur contaminant from an anode or cathode of a fuel cell, fuel processor or related electrochemical device.

### BACKGROUND OF THE INVENTION

Fuel cells and particularly polymer electrolyte membrane (“PEM”) fuel cells are actively under development by a large number of companies. These devices, while offering efficiency and environmental advantages, are too expensive at current prices to have a major market impact. Consequently, there is a world-wide effort to reduce the cost of these units.

Fuel cells are fueled primarily by methane, propane, and methanol, and other fuels such as ethanol, diesel, JP-8 and gasoline are under consideration. Typically, hydrogen is obtained from these fuels in a fuel processing unit that combines steam reforming with water-gas shifting and carbon monoxide cleanup. It is widely recognized that even 50 ppm of carbon monoxide (CO) in the fuel can coat the anode of the fuel cell, reducing the area available for hydrogen to react, and limiting the fuel cell current. Furthermore, sulfur is known to be a strong poison for fuel cell electrodes as well.

Recent research has shown a substantial degradation in fuel cell current when the fuel contained 50 ppb of H₂S (Uribe, et al., “Fuel Cell Electrode Optimization for Operation on Reformate and Air”, DOE 2002 Program Review, Fuel Cell for Transportation Program). Other researchers have shown that 50 ppm of H₂S in hydrogen can result in degradation (Mohtadi, et al., “Effects of Hydrogen Sulfide on the Performance of a PEMFC”, Electrochemical and Solid-State Letters, v. 6, n. 12, A272-A274, 2003). Furthermore, these researchers have shown that sulfur in the form of H₂S could be oxidized on an electrode at sufficiently high anodic overpotentials. This information, shown on a standard cyclic voltammogram, indicates that the voltage control techniques described below are applicable for sulfur removal. For example, these techniques can be applied to sulfur using the cyclic voltammogram described in the Uribe, et al. reference as a means of setting the voltage levels for the voltage control techniques. Furthermore, other sulfur compounds that show electro-oxidation on a cyclic voltammogram with practical voltage levels should be applicable for this invention. By reasonable voltage levels, we mean a voltage that can be applied to the cell by using the electrochemical device itself or an external voltage source.

Sulfur is widely found in hydrocarbon fuels and these techniques are applicable to a wide variety of fuels and fuel cells.

Cleaning an anode of an electrochemical energy converter by changing the potential of the anode was proposed by Bockris in “Basis of Possible Continuous Self Activation In an Electrochemical Energy Converter”, J. Electroanal. Chem., vol. 7, pp. 487-490 (1964). In his scheme, a cleaning current pulse of about 40 mA was used. During the time the pulse was on, cleaning was accomplished but little useful power was produced. When the pulse was off, power was produced using the cleaned electrode, which gradually became re-covered with contaminant. Consequently, this system is most attractive when the cleaning pulses are of short duration in the duty cycle. The cleaning pulses may consume energy, so the power produced must be larger than the power consumed by the cleaning pulses for a net gain in power to be realized.

Publications using and extending this approach have appeared, including International Publication No. WO 98/42038 by Stimming et al. applying this technology to PEM fuel cells, and Carrette, Friedrich, Huber and Stimming, “Improvement of CO Tolerance of Proton Exchange Membrane Fuel Cells by a Pulsing Technique”, PCCP, v. 3, n.3, Feb. 7, 2001, pp 320-324. The Stimming approach also used a cleaning current pulse of between 100 and 640 mA/cm² with varying pulse durations and frequencies. Square wave current pulses, similar to the work of Bockris, are used. In addition, Stimming has proposed using positive voltage pulses for cleaning. Stimming showed that this method could clean electrodes with 1 percent CO in the feed stream for laboratory, bench-top experiments.

Wang and Fedkiw, “Pulsed-Potential Oxidation of Methanol, I”, J. Electrochem. Soc., v. 139 n. 9, September 1992, 2519-2525, and “Pulsed-Potential Oxidation of Methanol, II”, v. 139, n. 11, 3151-3158, showed that pulsing a direct methanol fuel cell with positive square wave pulses of a certain frequency could result in a substantial increase in output current. The increase was attributed to cleaning intermediates, probably CO, from the electrode. It is expected that CO will be a poison when other hydrocarbon fuels are used directly in fuel cells.

Lakshmanan, et al., (Lakshmanan, Huang and Weidner, “Electrochemical Filtering of CO from Fuel-Cell Reformate”, Electrochemical and Solid-State Letters, 5 (12) A267-A270 (2002)) applied similar techniques to the removal of CO in a fuel processing cell located upstream of the fuel cell. This shows that these methods can be applied within the fuel processor as well as in the fuel cell.

The pulsing approaches used in the technical literature do not address pulsing waveform shapes other than square waves. In addition, methods of determining suitable waveform shapes for different electrodes, electrolytes, load characteristics, and operating conditions are not discussed. More powerful techniques are needed for electrode cleaning in fuel cells, particularly techniques that would allow the fuel cell to consistently and robustly operate with sulfur compounds present at even small levels in the fuel. This would simplify the reformer and reduce the stack size. The invention reported herein utilizes the inherent dynamical properties of the electrode to improve the fuel cell performance and arrive at a suitable pulsing waveform shape or electrode voltage control method to oxidize sulfur compounds at the electrode

### SUMMARY OF THE INVENTION

This invention relates to a method of optimizing a waveform of an electrical current applied to an electrode. The method includes the steps of: applying an electrical current to an electrode of a device; determining a waveform of the voltage or the current of the electrical current; representing the waveform by mathematical expressions or numbers; measuring a function of the device associated with the application of the electrical current; and varying the shape and frequency of the waveform to optimize the function of the device and thereby determine an optimized waveform of the electrical current to be applied to the electrode of the device. The application of the electrical current is effective to remove a sulfur contaminant from the electrode.

The invention also relates to another method of optimizing a waveform of an electrical current applied to an electrode. The method includes the steps of: applying an electrical current to an electrode of a device; determining a waveform of the voltage or the current of the electrical current; representing the waveform by a mathematical description such as a number of points or an analytical function characterized by a number of unknown coefficients and a fixed number of known functions; measuring a function of the device associated with the application of the electrical current; feeding the waveform description and the measurements to an algorithm, which may be in a computer program or other calculating device including manual calculations, including an optimization routine which uses the points or coefficients as independent variables for optimizing the function of the device; and performing the calculations to determine values of the points or coefficients which optimize the function of the device, and thereby determine an optimized waveform of the electrical current to be applied to the electrode of the device. The application of the electrical current is effective to remove a sulfur contaminant from the electrode.

The invention also relates to a method of removing a sulfur contaminant from an anode of a fuel cell. The method includes the steps of: applying an electrical current to the anode of the fuel cell; and pulsing the voltage of the electrical current during the application, such that the overvoltage at the anode is high during the pulses, and the overvoltage at the anode is low between the pulses.

The invention also relates to a method of removing sulfur contaminants from a fuel or air gas stream before it enters a fuel cell. The method includes the steps of: applying an electrical current to the anode or cathode of an electrochemical cell located upstream of the fuel cell; and pulsing the voltage of the electrical current during the application, such that the overvoltage at the anode or cathode is high during the pulses, and the overvoltage at the anode is low between the pulses.

The invention also relates to a method of operating a fuel cell. The method involves applying an overvoltage to the anode of the fuel cell by applying a voltage to the anode with respect to a reference electrode. The fuel contains a significant level of a sulfur contaminant, typically more than 1 ppb (parts per billion), and sometimes more than 10 ppb. The overvoltage is varied between a low value normally used for power production and a high value sufficiently high for cleaning the contaminant from the anode. The cyclic voltammogram may be used to estimate the high voltage for cleaning. This is done by setting the high viltage at or above the voltage from the oxidation peak voltage for the contaminant on the cyclic voltammogram. For the Uribe et al. reference, the high voltage would be set above 1.1 volts.

The invention also relates to another method of operating a fuel cell. The method includes the steps of: feeding a fuel to the fuel cell containing a significant level of a sulfur contaminant; and applying an overvoltage to an electrode of the fuel cell, and varying the overvoltage between a low value normally used for power production and a high value for cleaning the sulfur contaminant from the electrode.

The invention also relates to a pulsed anode of an electrical device operating with a significant level of a sulfur contaminant using a method of optimizing a waveform of an electrical current applied to the anode. The method includes the steps of: applying an electrical current to the anode; determining a waveform of the voltage or the current of the device; representing the waveform by mathematical expressions or numbers; taking measurements of a function of the device associated with the application of the electrical current; and varying the shape and frequency of the waveform to optimize the function of the device and thereby determine an optimized waveform of the electrical current to be applied to the anode of the device. The application of the electrical current is effective to remove the sulfur contaminant from the electrode.

The invention also relates to a fuel cell having a pulsed electrode including an oxidation pulse, and the fuel cell having a voltage booster to change the cell voltage during the oxidation pulse to a desired level. The voltage booster can be any of a number of standard or modified circuits designed to change a time varying voltage to a desired level or levels. Those skilled in the art could also design the circuit to help match the pulsed cell voltage to a desired electrical load.

The invention also relates to a fuel cell system comprising: a fuel cell having a pulsed electrode and operating with a fuel containing a significant level of a sulfur contaminant; and a fuel processor that is simplified compared to a fuel processor required when the same fuel cell is used without pulsing. For instance, a sulfur cleanup reactor may not be required or could be simpler with this approach.

The invention also relates to a method of operating a fuel cell where a sulfur contaminant is cleaned from an electrode, where the fuel cell during operation has a variation in anode and/or cathode overvoltage. The method comprises feeding back a portion of the current output of the fuel cell to a control circuit to vary the voltage waveform to maintain a desired current and cleaning the sulfur contaminant.

The invention also relates to a method of cleaning a sulfur contaminant from an electrode of an apparatus used in an electrochemical process, in which the electrode is cleaned by oxidizing the sulfur contaminant so that another reaction can proceed on the electrode, where the apparatus during operation has a variation in electrode overvoltage. The method comprises feeding back a portion of the current output of the apparatus to vary the voltage waveform to maintain a desired current and cleaning the sulfur contaminant.

The invention also relates to a method of cleaning a sulfur contaminant from an electrode of an apparatus used in an electrochemical process, in which the electrode is cleaned by oxidizing the sulfur contaminant so that another reaction can proceed on the electrode, where the apparatus during operation has a variation in electrode overvoltage. The method comprises measuring the current or voltage across the anode and cathode of the device, and utilizing that measurement as the input to a device to vary a load impedance that is in parallel or series with the useful load of the device to vary the voltage or current waveform at the electrodes to maintain a desired current and cleaning the sulfur contaminant.

The invention also relates to a method of removing a sulfur contaminant from an electrode of a fuel cell, comprising applying an electrical energy to the electrode of the fuel cell in the form of small voltage pulses to excite natural oscillations in fuel cell voltage during operation of the fuel cell, the voltage pulses being applied at the same frequency as the natural oscillations or at a frequency different from the natural oscillations. In some embodiments, the electrode is an anode and the electrical energy is an electrical current.

The invention also relates to a method of removing a sulfur contaminant from an anode or cathode of a fuel cell, comprising: applying an electrical current to the anode or cathode of the fuel cell; pulsing the voltage of the electrical current during the application; and controlling the pulsing with a control function to create a waveform or a frequency of the pulsing that removes the sulfur contaminant and maximizes the power output from the fuel cell.

The invention also relates to a method of removing a sulfur contaminant from an anode or cathode of a fuel cell, comprising: applying an electrical current to the anode or cathode of the fuel cell; and pulsing the voltage of the electrical current during the application, the pulsing exciting and maintaining a natural oscillation of the fuel cell system.

The invention also relates to a feedback control method of operating a fuel cell comprising applying voltage control to an anode of the fuel cell using the following algorithm:
a) determining a mathematical model that relates the instantaneous coverage of hydrogen and a sulfur contaminant to the overvoltage applied to the anode;
b) forming an observer that relates the instantaneous coverage of the hydrogen and the sulfur contaminant to the measured current of the fuel cell;
c) driving the estimated sulfur contaminant coverage to a low value by varying the overvoltage;
d) driving the estimated hydrogen coverage to a high value by varying the overvoltage; and
e) repeating steps a) through d) as necessary.

The invention also relates to a feedback control method of operating a fuel cell comprising applying voltage control to an anode of the fuel cell using the following algorithm:
a) determining a mathematical model that relates the instantaneous coverage of hydrogen and a sulfur contaminant to the overvoltage applied to the anode;
b) forming an observer that relates the instantaneous coverage of the hydrogen and the sulfur contaminant to the measured current of the fuel cell;
c) prescribing a desired trajectory of the instantaneous coverage of the hydrogen and the sulfur contaminant as a function of time;
d) forming a set of mathematical relationships from steps a), b) and c) that allows the current to be measured, the overvoltage to be prescribed and the instantaneous sulfur contaminant coverage and instantaneous hydrogen coverage to be predicted;
e) driving the sulfur contaminant coverage to a low value by varying the overvoltage according to step d);
f) driving the hydrogen coverage to a high value by varying the overvoltage according to step d); and
g) repeating steps a) through f) as necessary.

The invention also relates to a feedback control method of operating an electrochemical apparatus operated using a fuel containing a sulfur contaminant, the method comprising applying voltage control to an anode of the apparatus using the following algorithm:
a) determining a mathematical model that relates the instantaneous coverage of fuel and sulfur contaminant to the overvoltage applied to the anode;
b) forming an observer that relates the instantaneous coverage of the fuel and the sulfur contaminant to the measured current of the apparatus;
c) driving the estimated sulfur contaminant coverage to a low value by varying the overvoltage;
d) driving the estimated fuel coverage to a high value by varying the overvoltage; and
e) repeating steps a) through d) as necessary.

The invention further relates to a feedback control method of operating an electrochemical apparatus operated using a fuel containing a sulfur contaminant, the method comprising applying voltage control to an anode of the apparatus using the following algorithm:
a) determining a mathematical model that relates the instantaneous coverage of fuel and sulfur contaminant to the overvoltage applied to the anode;
b) forming an observer that relates the instantaneous coverage of the fuel and the sulfur contaminant to the measured current of the apparatus;
c) prescribing a desired trajectory of the instantaneous coverage of the fuel and sulfur contaminant as a function of time;
d) forming a set of mathematical relationships from steps a), b) and c) that allows the current to be measured, the overvoltage to be prescribed and the instantaneous sulfur contaminant coverage and instantaneous fuel coverage to be predicted;
e) driving the sulfur contaminant coverage to a low value by varying the overvoltage according to step d);
f) driving the fuel coverage to a high value by varying the overvoltage according to step d); and
g) repeating steps a) through f) as necessary.

Various advantages of this invention will become apparent to those skilled in the art from the following detailed description of the preferred embodiment, when read in light of the accompanying drawings.

### BRIEF DESCRIPTION OF THE DRAWINGS

FIG. 1 shows voltage and current waveforms for a methanol fuel cell, showing that negative pulsing delivers the most current.

FIG. 2 shows the charge delivered by the methanol fuel cell during the experiments.

FIGS. 3a-3c show voltage waveforms and the resulting current for the methanol fuel cell.

FIG. 4 shows the charge delivered by the various waveform shapes in FIGS. 3a-3c.

FIG. 5 is a representation of a voltage waveform by a fixed number of points.

FIG. 6 shows voltage and current waveforms of a fuel cell using a feedback control technique based on natural oscillations in voltage to clean the electrode.

### DETAILED DESCRIPTION AND PREFERRED EMBODIMENTS OF THE INVENTION

Methods of Removing Sulfur Contaminants from Electrochemical Processes

The present invention relates in general to methods of removing sulfur contaminants from electrochemical processes, and in particular to processes using fuels that contain such contaminants. The methods can be applied to any sulfur contaminant that is an electrode poison where the poison can be electro-oxidized in a cyclic voltammetry experiment. Some nonlimiting examples of sulfur contaminants to which the methods may be applied include hydrogen sulfide (H₂S), sulfur, carbonyl sulfide, mercaptans, sulfides, disulfides, thiophenes, benzothiophenes, dibenzothiophenes, and benzonapthothiophenes and heavier sulfur compounds. In general, the methods can be applied to a sulfur contaminant provided that a cyclic voltammogram shows that the contaminant can be oxidized at a certain realizable voltage, just as the cyclic voltammogram from the Uribe et al. reference shows that H₂S can be oxidized at voltages above 1.1 volts. The cell may be a fuel cell or a special cell located upstream of the fuel cell in the fuel processor or between a fuel processor and a fuel cell. In some particular embodiments, outlined herein, the invention relates to methods of removing sulfur from the anode or cathode of a fuel cell or the anode or cathode of a special cell located upstream of the fuel cell, thereby maximizing or otherwise optimizing a performance measure such as the power output or current of the fuel cell.

The methods usually involve varying the overvoltage of an electrode. This can be done by varying the load on the device, i.e., by placing a second load that varies in time in parallel with the primary load, or by using a feedback system that connects to the anode, the cathode and a reference electrode. A feedback system that is commonly used is the potientostat. In some cases the reference electrode can be the cathode; in other cases it is a third electrode.

In the experiments cited previously, the anodic overvoltage required to oxidize H_{S}S was between 0.9 and 1.2 volts. Higher voltages may be required in practice. Since a fuel cell operates at output voltages less than about 1 volt, and since the overvoltage is a voltage loss, the cell may be required to operate at a negative voltage to perform the H₂S oxidation. As stated earlier, this may require external power to the cell. This power could be supplied by other cells within the fuel cell stack, by an external battery, a capacitor or other sources of power. The fuel cell may or may not charge the battery or capacitor prior to the cleaning.

Broadly, the different methods involve the following concepts:

1. Control of the voltage waveform during a pulsed cleaning operation to minimize the magnitude or duration of the pulse, or to satisfy some other system constraint.

2. A feedback control technique based on a natural oscillation in electrochemical system voltage to maintain a desired current for cleaning sulfur contaminants.

Improved Waveform for Pulsing a Fuel Cell Anode or Cathode to Maximize the Current or Power Produced, and General Method for Optimizing the Pulsing Waveform Applied to Any Electrode

In a preferred embodiment, the present invention provides a general method for optimizing the pulsing waveform that can be applicable to any type of electrode, and may have applications well beyond fuel cells in areas such as battery charging, electrode sensors, analytical chemistry, and material manufacturing.

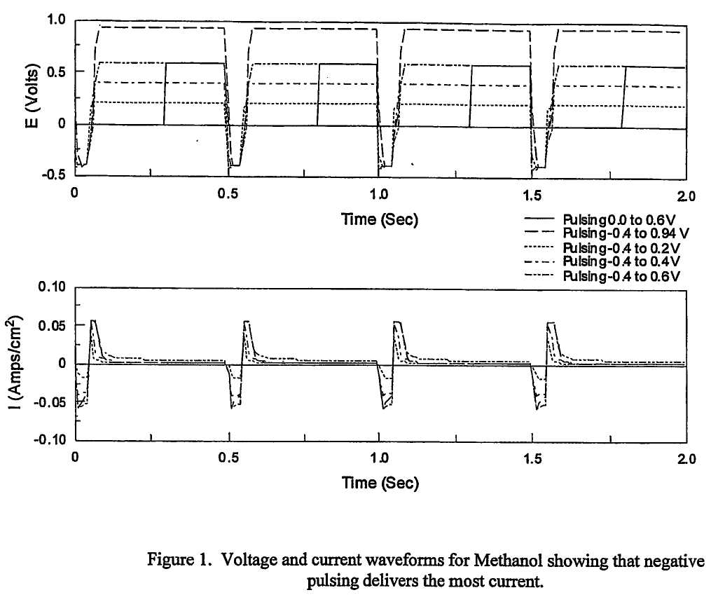

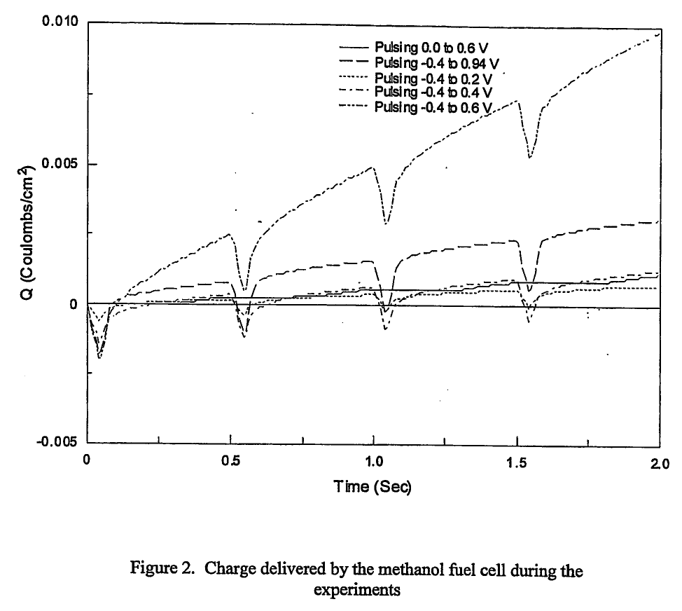

Experiments were performed with a standard three electrode cell containing 1.0 M methanol and 0.5 M sulfuric acid. The anode was platinum and the cathode was a saturated calumel electrode (“SCE”). This was a batch system with the fuel (methanol) mixed with the electrolyte (sulfuric acid) in the cell. The anode voltage was controlled by a potentiostat with a voltage waveform that could be generated either by the potentiostat directly or by externally triggering the potentiostat with a programmable function generator. The resulting data, shown in FIG. 1 for five different experiments, show that the current output is larger and substantial when the waveform is made negative (relative to the cathode) during a short cleaning pulse. FIG. 2 illustrates this better, showing that the charge delivered is larger when the cleaning pulse is negative and the voltage level during power production is at 0.6 volts (the top curve—dashed), which is near the peak methanol oxidation potential from a cyclic voltammogram. For comparison the solid black curve has a cleaning potential at 0.0 volts and power production at 0.6 volts. Notice that the current traces have a positive and a negative component to them. When the current is positive, the cell is delivering current. When the current is negative, the cell is receiving current. Consequently, it is desirable to maximize the positive current and minimize the negative current.

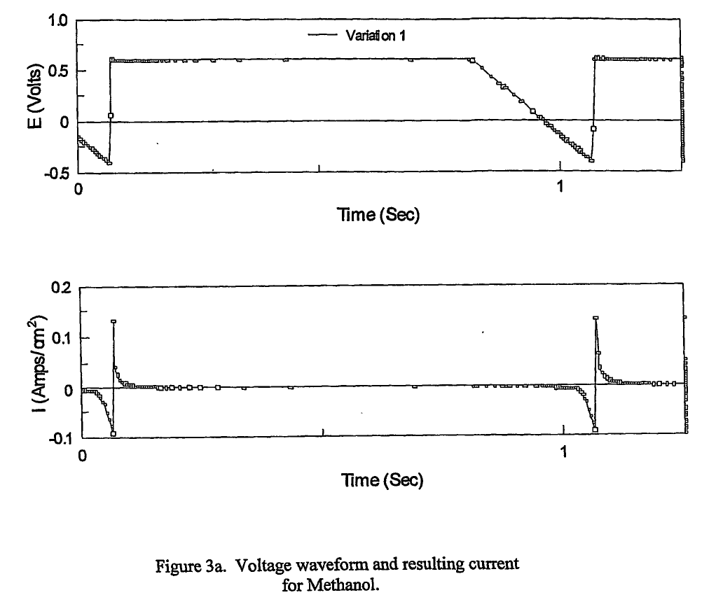

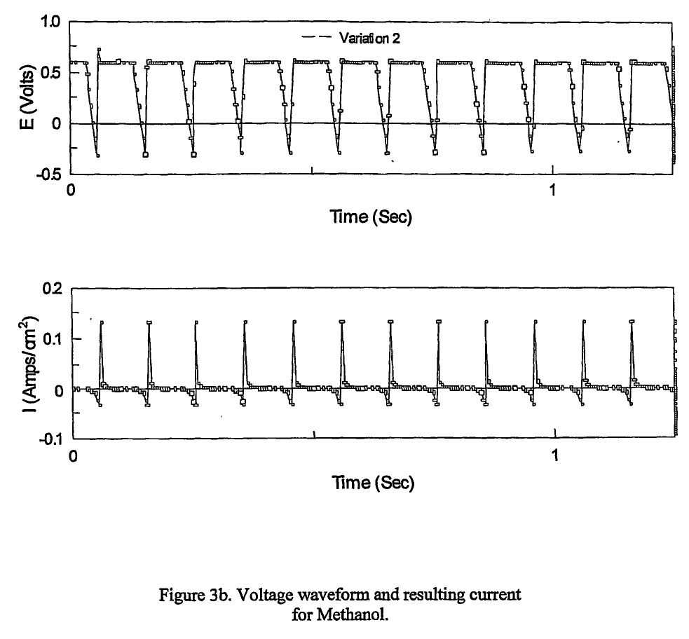

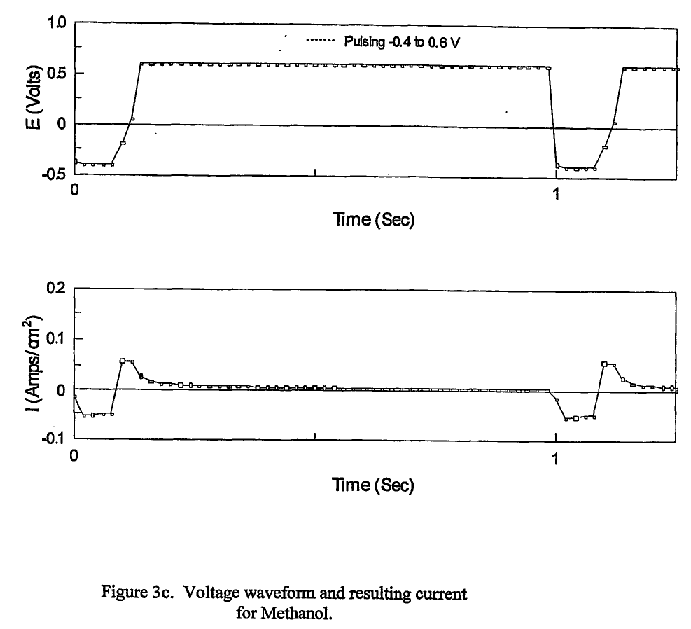

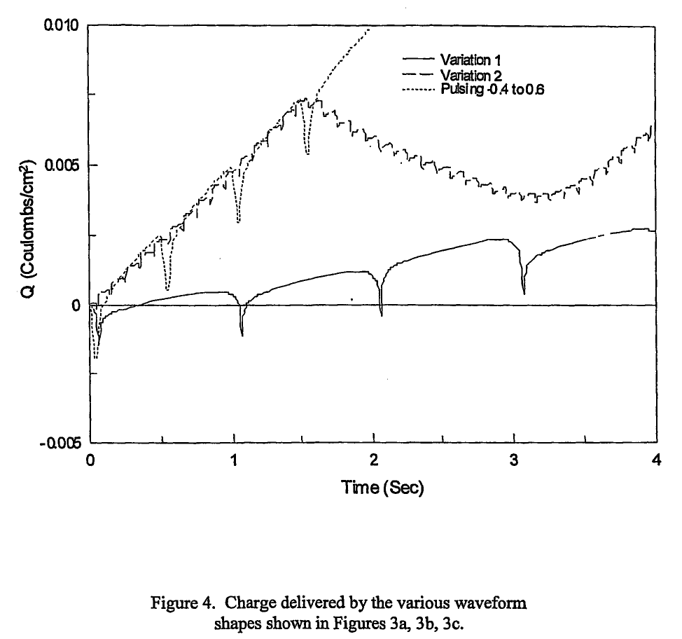

To influence the positive and negative currents, we varied the shape of the voltage pulses. FIGS. 3a, 3b and 3c show that varying the voltage shapes can strongly influence the shape of the current traces and can reduce the negative current. FIG. 4 illustrates the charge delivered by the various waveform shapes shown in FIGS. 3a, 3b and 3c.

The results of these experiments indicate that the waveform can be optimized by a systematic, computational procedure in order to deliver substantially more power than existing fuel cells. The experiments show that varying the waveform can significantly vary the current output.

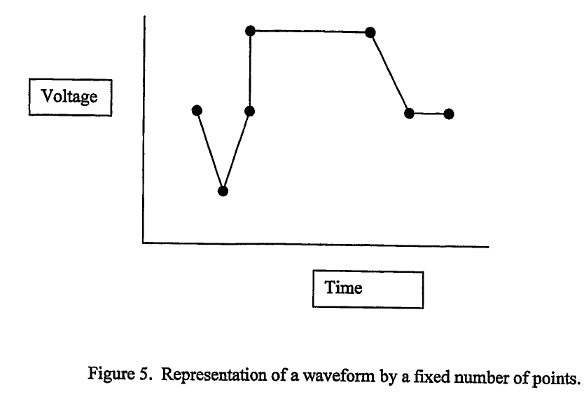

To illustrate the method, consider a waveform to be represented by a fixed number of points, as shown in FIG. 5. The number of points is arbitrary, but the more points, the longer the optimization time that is required. The waveform is a voltage or current waveform that is connected to the anode of a fuel cell, such that the anode is operated at that voltage, or perhaps is operated at that voltage plus or minus a fixed offset voltage. The offset voltage may vary slowly with the operating conditions due to, for instance, changes in the load. The waveform variation is much faster than any variation in the offset voltage.

This waveform pattern is fed to the anode and repeated at a frequency specified by the points, as the figure illustrates. Measurements are made of the power or current or other performance parameter, whichever is most appropriate, delivered by the fuel cell. The performance parameter and waveform points are then fed to an algorithm, which may be in a computer program or hand calculation, which optimizes the waveform shape to maximize the performance, such as power or current delivered.

The optimum waveform can thus be determined for the specific fuel cell electrode and operating conditions. This optimizing procedure can be repeated as often as necessary during operation to guard against changes in the electrode or other components over time or for different operating conditions.

Mathematically, the points describing the waveform can be considered to be independent variables for the optimization routine. The net current or power produced (current or power that is output minus any current or power supplied to the electrode) is the objective function to be optimized. A person skilled in the art of optimization could select a computer algorithm to perform the optimization. Typical algorithms might include steepest descent, derivative-free algorithms, annealing algorithms, or many others well-known to those skilled in the art.

Alternatively, the waveform could be represented by a set of functions containing one or more unknown coefficients. These coefficients are then analogous to the points in the preceding description, and may be treated as independent variables in the optimization routine. As an example, the waveform could be represented by a Fourier Series, with the coefficient of each term in the series being an unknown coefficient.

Model Based Feedback Control of the Electrode Voltage

When an electrode is pulsed, some loss of useful energy due to the pulse is inevitable. This loss is reduced when the fraction of time spent pulsing is minimized. Our next modification involves intelligent control of the voltage waveform. This may be done to minimize the magnitude or duration of the pulse, or to satisfy some other system constraint such as avoiding conditions that decrease reliability. Here, we present a method of using a high overvoltage to achieve a low coverage of sulfur on the anode and then a much smaller overvoltage to maintain a high hydrogen coverage and thus high current from the electrode. Over time, the hydrogen coverage will gradually degrade and the method will be repeated periodically.

The method uses a model based upon the coverage of the electrode surface with hydrogen and sulfur. The model includes mathematical techniques to control the voltage or current of the electrode in order to (1) clean the surface of sulfur by raising the overvoltage to minimize the sulfur coverage and (2) maintain the surface at high hydrogen coverage by maximizing the hydrogen coverage. This two-part optimization and control problem can be solved by many techniques. The techniques of feedback linearization, sliding mode control, and optimal control are illustrated below by a series of examples relating to the coverage of the electrode surface with hydrogen (θ_{H}) and CO (θ_{co}). These same examples can be used for sulfur control by changing the CO related variables to sulfur related variables. However, the form of the mathematical model governing the CO coverage dynamics must be modified to predict sulfur compound coverage dynamics. Modifications to the model can be made by someone skilled in the art of electrochemical modeling and experimentation.

Examples 1 through 3 are based upon the oxidation equations for CO. Equations can be developed for H₂S oxidation or for oxidation of other sulfur contaminants that will also be differential equations, but will contain different mathematical expression. Consequently, the procedure for H₂S oxidation and other sulfur contaminants is analogous to this example.

### EXAMPLE 1

### Feedback Linearization

The steps are as follows.

1. Develop a model for the fuel cell in question that relates the time derivative of θ_{H} and θ_{co} to the overvoltage. The model involves some unknown coefficients that must be found experimentally. For instance, scientists at Los Alamos National Laboratory have proposed the following model (T. E. Springer, T. Rockward, T. A. Zawodzinski, S. Gottesfeld, Journal of the Electrochemical Society, 148, A11-A23 (2001), which is incorporated by reference). The unknown coefficients are the k's and the b's, and η is the overvoltage

$${\dot{θ}}_{CO} = {k}_{fc} {P}_{CO} ( 1 - {θ}_{CO} - {θ}_{H} ) - {b}_{fc} {k}_{fc} {θ}_{CO} - {k}_{ec} {θ}_{CO} {ⅇ}^{\frac{η}{{b}_{c}}}$$

$${\dot{θ}}_{H} = {k}_{fH} {{P}_{H} ( 1 - {θ}_{CO} - {θ}_{H} )}^{2} - {b}_{fH} {k}_{fH} {θ}_{H}^{2} - 2 {k}_{eH} {θ}_{H} sinh ( \frac{η}{{b}_{H}} )$$

2. Develop a model, called a set of observers that relates θ_{H} and θ_{co} to the measured current of the cell, j_{H}. The observer equations are numerically integrated in real time and will converge to the coverage values, θ_{H} and θ_{co}. The parameters 1₁ and 1₂ determine the rate of convergence.

$${\dot{\hat{θ}}}_{CO} = {k}_{fc} {P}_{CO} ( 1 - {\hat{θ}}_{CO} - {\hat{θ}}_{H} ) - {b}_{fc} {k}_{fc} {\hat{θ}}_{CO} - {k}_{ec} {\hat{θ}}_{CO} {ⅇ}^{\frac{η}{{b}_{c}}} + \\ {l}_{1} ( {θ}_{H} - {\hat{θ}}_{H} )$$

$${\dot{\hat{θ}}}_{H} = {k}_{fH} {{P}_{H} ( 1 - {\hat{θ}}_{CO} - {\hat{θ}}_{H} )}^{2} - {b}_{fH} {k}_{fH} {\hat{θ}}_{H}^{2} - 2 {k}_{eH} {\hat{θ}}_{H} sinh ( \frac{η}{{b}_{H}} ) + \\ {l}_{2} ( {θ}_{H} - {\hat{θ}}_{H} )$$

$${θ}_{H} = \frac{{j}_{H}}{2 {k}_{eH} sinh ( \frac{η}{{b}_{H}} )}$$

3. Develop a desired trajectory for the variation of θ_{co} and θ_{H} in time. This trajectory may be chosen to maximize durability of the cell, minimize the expected overvoltage changes, or for some other reason. That is, constraints may be prescribed on any of the variables. In this example, we use a first order trajectory to reach the desired state values θ_{H}^{d} and θ_{co}^{d}.
\dot{θ}_{H}=−α(θ_{H}−θ_{H}^{d})
\dot{θ}_{co}=−β(θ_{co}−θ_{co}^{d})

4. Equate the time derivative of θ_{co} in the trajectory (3) to the time derivative of θ_{co} in the observer model (2). Equate the time derivative Of θ_{H} in the trajectory (4) to the time derivative of θ_{H} in the observer model (2).

$$- β {\hat{θ}}_{CO} = {k}_{fc} {P}_{CO} ( 1 - {\hat{θ}}_{CO} - {\hat{θ}}_{H} ) - {b}_{fc} {k}_{fc} {\hat{θ}}_{CO} - {k}_{ec} {\hat{θ}}_{CO} {ⅇ}^{\frac{η}{{b}_{c}}} \\ - α {\hat{θ}}_{H} = {k}_{fH} {{P}_{H} ( 1 - {\hat{θ}}_{CO} - {\hat{θ}}_{H} )}^{2} - {b}_{fH} {k}_{fH} {\hat{θ}}_{H}^{2} - 2 {k}_{eH} {\hat{θ}}_{H} sinh ( \frac{η}{{b}_{H}} )$$

5. Solve for the overvoltage from the θ_{co} equation in (5).

$$η = ln ( \frac{- β ( {\hat{θ}}_{CO} - {\hat{θ}}_{CO}^{d} ) - {k}_{fc} {P}_{CO} ( 1 - {\hat{θ}}_{CO} - {\hat{θ}}_{H} ) + {b}_{fc} {k}_{fc} {\hat{θ}}_{CO}}{- {k}_{ec} {\hat{θ}}_{CO}} ) {b}_{C}$$

6. Solve for the overvoltage from the θ_{H} equation in (5).

$$η = {sinh}^{- 1} ( \frac{- α ( {\hat{θ}}_{H} - {\hat{θ}}_{H}^{d} ) - {k}_{fH} {{P}_{H} ( 1 - {\hat{θ}}_{CO} - {\hat{θ}}_{H} )}^{2} + {b}_{fH} {k}_{fH} {\hat{θ}}_{H}^{2}}{- 2 {k}_{eH} {\hat{θ}}_{H}} ) {b}_{H}$$

7. Vary the overvoltage according to 6 to drive θ_{co} to a desired value.

8. When θ_{co} reaches the desired value, vary the overvoltage according to 7 to drive θ_{H} to a desired value.

9. Repeat when needed.

The results of this example algorithm are shown in FIG. 10. The upper plot shows the overpotential as a function of time, with the overpotential high for about 13 seconds and low for the remaining time. The lower plot shows the coverage of CO being reduced from about 0.88 to 0.05 by applying step 5, followed by the coverage of hydrogen being increased from near zero to 0.95 by applying step 6. The hydrogen coverage will gradually degrade over time and the process will be repeated periodically.

### EXAMPLE 2

### Sliding Mode Control

The exact feedback linearization technique presented above may not always be achievable due to the uncertainty of the model parameters (k's and b's). Therefore sliding mode control techniques can be applied to reduce sensitivity to the model parameters. The design procedure is as follows:

1. Develop a model, called a set of observers, that relates θ_{H} and θ_{co} to the measured current of the cell, j_{H}. The observer equations are numerically integrated in real time and will converge to the coverage values, θ_{H} and θ_{co}. The parameters 1₁ and 1₂ determine the rate of convergence.

$${\dot{\hat{θ}}}_{CO} = {k}_{fc} {P}_{CO} ( 1 - {\hat{θ}}_{CO} - {\hat{θ}}_{H} ) - {b}_{fc} {k}_{fc} {\hat{θ}}_{CO} - {k}_{ec} {\hat{θ}}_{CO} {ⅇ}^{\frac{η}{{b}_{c}}} + \\ {l}_{1} ( {θ}_{H} - {\hat{θ}}_{H} )$$

$${\dot{\hat{θ}}}_{H} = {k}_{fH} {{P}_{H} ( 1 - {\hat{θ}}_{CO} - {\hat{θ}}_{H} )}^{2} - {b}_{fH} {k}_{fH} {\hat{θ}}_{H}^{2} - 2 {k}_{eH} {\hat{θ}}_{H} sinh ( \frac{η}{{b}_{H}} ) + \\ {l}_{2} ( {θ}_{H} - {\hat{θ}}_{H} )$$

$${θ}_{H} = \frac{{j}_{H}}{2 {k}_{eH} sinh ( \frac{η}{{b}_{H}} )}$$

2. Develop a desired trajectory for the variation of θ_{co} and θ_{H} in time. This trajectory may be chosen to maximize durability of the cell, minimize the expected overvoltage changes, or for some other reason. That is constraints may be prescribed on any of the variables. In this example, we use a first order trajectory to reach the desired state values θ_{H}^{d} and θ_{co}^{d}.
\dot{θ}_{H}−−α(θ_{H}−θ_{H}^{d})
\dot{θ}_{co}=−β(θ_{co}−θ_{co}^{d)}

3. Design the CO sliding surface as the CO coverage minus the integral of the desired state trajectory:
S_{co}=\hat{θ}_{co}−∫β(\hat{θ}_{co}−θ_{co}^{d})

4. Design control as η=M*sign(S_{co}), where M is some constant used to enforce sliding mode.

5. After sliding mode exists the equivalent control is defined as:

$$η = ln ( \frac{- β ( {\hat{θ}}_{CO} - {\hat{θ}}_{CO}^{d} ) - {k}_{fc} {P}_{CO} ( 1 - {\hat{θ}}_{CO} - {\hat{θ}}_{H} ) + {b}_{fc} {k}_{fc} {\hat{θ}}_{CO}}{- {k}_{ec} {\hat{θ}}_{CO}} ) {b}_{C}$$

6. Design the H₂ sliding surface as the H₂ coverage minus the integral of the desired state trajectory
S_{H}=\hat{θ}_{H}−∫α(\hat{θ}_{H}−θ_{H}^{d})

7. Design control as η=M*sign(S_{H}), where M is some constant used to enforce sliding mode.

8. After sliding mode exists the equivalent control is defined as:

$$η = {sinh}^{- 1} ( \frac{- α ( {\hat{θ}}_{H} - {\hat{θ}}_{H}^{d} ) - {k}_{fH} {{P}_{H} ( 1 - {\hat{θ}}_{CO} - {\hat{θ}}_{H} )}^{2} + {b}_{fH} {k}_{fH} {\hat{θ}}_{H}^{2}}{- 2 {k}_{eH} {\hat{θ}}_{H}} ) {b}_{H}$$

9. Vary the overvoltage according to 4 to drive θ_{co} to a desired value.

10. When θ_{co} reaches the desired value, vary the overvoltage according to 7 to drive θ_{H} to a desired value.

11. Repeat when needed.

### EXAMPLE 3

### Optimal Control

Optimal control can also be implemented to minimize the power applied to the cell used to stabilize the hydrogen electrode coverage, hence maximizing the output power of the cell. The steps are as follows:

1. Develop a model, called a set of observers, that relates θ_{H} and θ_{co} to the measured current of the cell, j_{H}. The observer equations are numerically integrated in real time and will converge to the coverage values, θ_{H} and θ_{co}. The parameters 1₁ and 1₂ determine the rate of convergence.

$${\dot{\hat{θ}}}_{CO} = {k}_{fc} {P}_{CO} ( 1 - {\hat{θ}}_{CO} - {\hat{θ}}_{H} ) - {b}_{fc} {k}_{fc} {\hat{θ}}_{CO} - {k}_{ec} {\hat{θ}}_{CO} {ⅇ}^{\frac{η}{{b}_{c}}} + \\ {l}_{1} ( {θ}_{H} - {\hat{θ}}_{H} )$$

$${\dot{\hat{θ}}}_{H} = {k}_{fH} {{P}_{H} ( 1 - {\hat{θ}}_{CO} - {\hat{θ}}_{H} )}^{2} - {b}_{fH} {k}_{fH} {\hat{θ}}_{H}^{2} - 2 {k}_{eH} {\hat{θ}}_{H} sinh ( \frac{η}{{b}_{H}} ) + \\ {l}_{2} ( {θ}_{H} - {\hat{θ}}_{H} )$$

$${θ}_{H} = \frac{{j}_{H}}{2 {k}_{eH} sinh ( \frac{η}{{b}_{H}} )}$$

2. Develop a cost function used to minimize the power applied to the cell as the CO coverage is driven to the desired value θ_{co}^{d}. Where A and B are the weights and T₁ is the time interval for the CO control to be applied.

$${\int }_{0}^{{T}_{1}} ( {A ( {\hat{θ}}_{CO} - {θ}_{CO}^{d} )}^{2} + β {η}^{2} ) ⅆ t$$

3. Solve for the overvoltage to drive CO to the desired value by applying dynamic programming techniques as described in Kirk, Donald E., Optimal Control Theory, Englewood Cliffs, N.J., Prentice Hall Inc., 1970. Apply the overvoltage for time zero at the lower limit of integration.

4. Develop a cost function used to maximize the power output of the cell as the H₂ coverage is driven to the desired value ^{θ}H^{d}. Where A and B are the weights and T₂-T₁ is the time interval for the hydrogen control to be applied.

$${\int }_{{T}_{1}}^{{T}_{2}} ( {A ( {\hat{θ}}_{H} - {θ}_{H}^{d} )}^{2} - {B ( {E}_{0} - η )}^{2} {I}^{2} ) ⅆ t$$

5. Solve for the overvoltage as in step 3. Apply the overvoltage for time T₁ to T₂.

6. Repeat as necessary.

A Feedback Control Technique Based upon Natural Oscillations in Fuel Cell Voltage to Clean the Electrode

It has been known for some time that some electrodes, when operated as an anode with hydrogen and carbon monoxide, can result in an oscillating current or voltage. In fact this has been known for other competing reactions on electrodes as well. One explanation of this effect is as follows for a system operated at constant current. On an initially clean electrode, the hydrogen reacts and the carbon monoxide begins to poison the surface, resulting in an increasing overvoltage. At a certain overvoltage, the CO is oxidized to CO₂ and the poison is removed, decreasing the overvoltage back to nearly the original, clean surface value. Deibert and Williams (“Voltage oscillations of the H2/CO system”, J. Electrochemistry Soc., 1969) showed that these voltage oscillations were quite strong at levels of CO of 10,000 ppm or 1 percent. However, the oscillations disappeared when the system was operated at 5 percent CO.

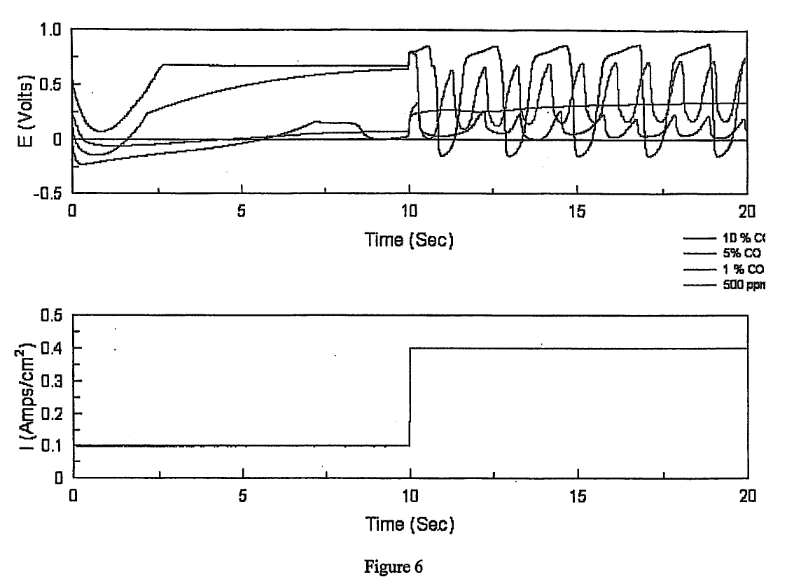

In FIG. 6 we show data obtained in our laboratory using a 5 cm² fuel cell. These data were obtained at constant current operation a PAR Model 273 Potentiostat operated in the galvanostatic mode. Hydrogen fuel was used with four different levels of CO: 500 ppm CO, 1 percent, 5 percent and 10 percent. The figure shows that when the current is increased to 0.4 amps and the concentration of CO is 1 percent or greater, the cell voltage begins to oscillate with an amplitude that is consistent with the amplitudes expected for CO oxidation. Furthermore, the amplitude increases as the CO level in the fuel increases. These same oscillations are expected when a sulfur compound contaminates the fuel.

In the present application to sulfur contaminants, we first describe a method of maintaining a constant current by varying the voltage similar to FIG. 6. Next we describe using this system to follow a varying current of power.

To accomplish this, a feed back control system is used to measure the current of the fuel cell, compare it to a desired value and adjust the waveform of the anode voltage to achieve that desired value. Essentially, this will reproduce a voltage waveform similar to FIG. 6.

The controller to be used is any control algorithm or black box method that does not necessarily require a mathematical model or representation of the dynamic system as described in Passino, Kevin M., Stephen Yurkovich, Fuzzy Control, Addison Wesley Longman, Inc., 1998. The control algorithm may be used in accordance with a voltage following or other buffer circuit, together with any necessary external power, that can supply enough power to cell to maintain the desired overpotential at the anode. External power will typically be required to power the control circuit and to maintain the oscillations, particularly if the cell voltage is less than zero during the oscillation. However, in some cases it may be more advantageous to not incorporate the voltage follower in the control circuit, since in some cases external power will not be required to maintain the overvoltage.

The resulting output of the controller will be similar to that in FIG. 6, and with the addition of a voltage boosting circuit the cell may be run at some desired voltage.

In some cases, the natural oscillations of voltage may be maintained by providing pulses of the proper frequency and duration to the anode or cathode of the device to excite and maintain the oscillations. Since this is a nonlinear system, the frequency may be the same as or different from the frequency of the natural oscillations. The pulsing energy may come from an external power source or from feeding back some of the power produced by the fuel cell. The fed back power can serve as the input to a controller that produces the pulses that are delivered to the electrode.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

1-32. (canceled)

33. A method of optimizing a waveform of an electrical current applied to an electrode, in order to remove a sulfur contaminant from the electrode, comprising the steps of:
(a) applying an electrical current to an electrode of a device;
(b) determining a waveform of the voltage or the current of the electrical current;
(c) representing the waveform by mathematical expressions or numbers;
(d) measuring a function of the device associated with the application of the electrical current; and
(e) varying the shape and frequency of the waveform to optimize the function of the device and thereby determine an optimized waveform of the electrical current to be applied to the electrode of the device;
(f) wherein the application of the electrical current is effective to remove the sulfur contaminant from the electrode.

34. A method according to claim 33 wherein step (c) comprises representing the waveform by a mathematical description such as a number of points or an analytical function characterized by a number of unknown coefficients and a fixed number of known functions; and step (e) comprises feeding the waveform description and the measurements to an algorithm, which may be in a computer program or other calculating device including manual calculations, including an optimization routine which uses the points or coefficients as independent variables for optimizing the function of the device, and performing the calculations to determine values of the points or coefficients which optimize the function of the device, and thereby determine an optimized waveform of the electrical current to be applied to the electrode of the device.

35. A method according to claim 33 wherein the electrode is an anode or cathode of a fuel cell, wherein the function is a current output, a power output or a specified load which may vary in time of the fuel cell, and wherein the optimizing of the function is optimizing the net current or the net power produced by the fuel cell or the matching of the steady or time-varying load.

36. A feedback control method of operating an electrochemical apparatus operated using a fuel containing a sulfur contaminant, in order to remove the sulfur contaminant from an electrode of the apparatus, the method comprising applying voltage control to the electrode using the following algorithm:
(a) determining a mathematical model that relates the instantaneous coverage of the fuel and the sulfur contaminant to the overvoltage applied to the electrode;
(b) forming an observer that relates the instantaneous coverage of the fuel and the sulfur contaminant to the measured current of the apparatus;
(c) driving the estimated sulfur contaminant coverage to a low value by varying the overvoltage;
(d) driving the estimated fuel coverage to a high value by varying the overvoltage; and
(e) repeating steps (a) through (d) as necessary.

37. A method according to claim 36 wherein the algorithm includes the additional steps, after step (b), of:
(bi) prescribing a desired trajectory of the instantaneous coverage of the fuel and the sulfur contaminant as a function of time; and
(bii) forming a set of mathematical relationships from steps (a), (b) and (bi) that allows the current to be measured, the overvoltage to be prescribed and the instantaneous sulfur contaminant coverage and instantaneous fuel coverage to be predicted.

38. A method according to claim 36 wherein the electrochemical apparatus is a fuel cell and the overvoltage is varied by changing the fuel cell voltage, current or external impedance.

39. A method of removing a sulfur contaminant from an electrode comprising:
applying an electrical current to the electrode; and
pulsing the voltage of the electrical current during the application, such that the overvoltage at the electrode is high during the pulses, and the overvoltage at the electrode is low between the pulses;
where the electrode is an electrode of a fuel cell, or the electrode is part of an electrochemical cell located upstream of a fuel cell and the method removes the sulfur contaminant from a fuel or air stream before it enters the fuel cell.

40. A method according to claim 39 wherein the electrode is an electrode of a fuel cell, and comprising an additional step of equipping the fuel cell with a voltage boosting circuit to change the high value of the overvoltage to a desired level.

41. A method according to claim 39 where the energy for the pulsing comes from the output of a fuel cell or from external energy or from energy produced by the fuel cell and stored in a battery, capacitor or similar device, and is fed back to one or more cells to vary the voltage waveform to clean the sulfur contaminant and maintain the desired operating voltage, current or power.

42. A method according to claim 39 wherein the steps of applying and pulsing are applied to both an electrode of a fuel cell and the electrode of an electrochemical cell located upstream of the fuel cell.
